(19) United States
(12) Patent Application Publication
(10) Pub. No.: US 2006/0130018 A1
(43) Pub. Date: Jun. 15, 2006

(54) Method and apparatus for implementing a codeless intrinsic framework for embedded system processors

(76) Inventor: Cheng-Hsueh Andrew Hsieh, San Jose, CA (US)

Correspondence Address: LAWRENCE CHO;C/O PORTFOLIOIP, P. O. BOX 52050, MINNEAPOLIS, MN, 55402, US

(21) Appl. No.: 10/996,226

(22) Filed: Nov. 23, 2004

(51) Int. Cl. G06F 9/45

(52) U.S. Cl. 717/140

(57) ABSTRACT

A method for compiling code includes generating assembly code for an instruction in the code that is to be performed by a first system. An instruction in the code that is supported by a second system is identified. A directive is generated that directs the second system to perform the instruction. Other embodiments are described and claimed.

### FIELD

An embodiment of the present invention relates to tools, such as compilers and development vehicles, for developing software for embedded system processors. More specifically, an embodiment of the present invention relates to a method and apparatus for implementing a codeless intrinsic framework for embedded system processors.

### BACKGROUND

When developing software for embedded systems, it is desirable to be able to test the software by accessing components in the embedded systems to determine whether the software is performing appropriate operations. In the past, when a good source level debugger was unavailable for an embedded system, software developers resorted to adding instructions in the source code, such as print statements for example, that prompted the embedded system to generate output which were used to diagnose the software.

When instructions were added to the source code, even only for diagnostic purposes, the additional instructions often resulted in execution penalties that could affect the very parameter that the software developer wished to test. This was an undesirable result that defeated the very purpose of adding the source code. Furthermore, after debugging the software, software developers would often have to remove the additional instructions and perform additional testing on the original source code for quality assurance. Having to test both developmental and production versions of the software required additional time and resources which was also undesirable. In addition, some embedded system processors lacked the code space to support the additional source code which made this approach infeasible.

Thus, what is needed is an efficient and effective method and apparatus for testing software for embedded system processors requiring limited code space support.

### BRIEF DESCRIPTION OF THE DRAWINGS

The features and advantages of embodiments of the present invention are illustrated by way of example and are not intended to limit the scope of the embodiments of the present invention to the particular embodiments shown.

FIG. 1 is a block diagram of an exemplary computer system in which an example embodiment of the present invention may be implemented.

FIG. 2 is a block diagram that illustrates a compiler according to an example embodiment of the present invention.

FIG. 3 is a block diagram that illustrates a development vehicle according to an example embodiment of the present invention.

FIG. 4 illustrates an array pointer generated by a monitor unit according to an example embodiment of the present invention.

FIG. 5 is a flow chart of a method for compiling code according to an example embodiment of the invention.

FIG. 6 is a flow chart illustrating a method for implementing no-operation instructions according to example embodiment of the present invention.

FIG. 7 is a flow chart of a method for implementing a directional program counter according to an example embodiment of the present invention.

### DETAILED DESCRIPTION

In the following description, for purposes of explanation, specific nomenclature is set forth to provide a thorough understanding of embodiments of the present invention. However, it will be apparent to one skilled in the art that specific details in the description may not be required to practice the embodiments of the present invention. In other instances, well-known components, programs, and procedures are shown in block diagram form to avoid obscuring embodiments of the present invention unnecessarily.

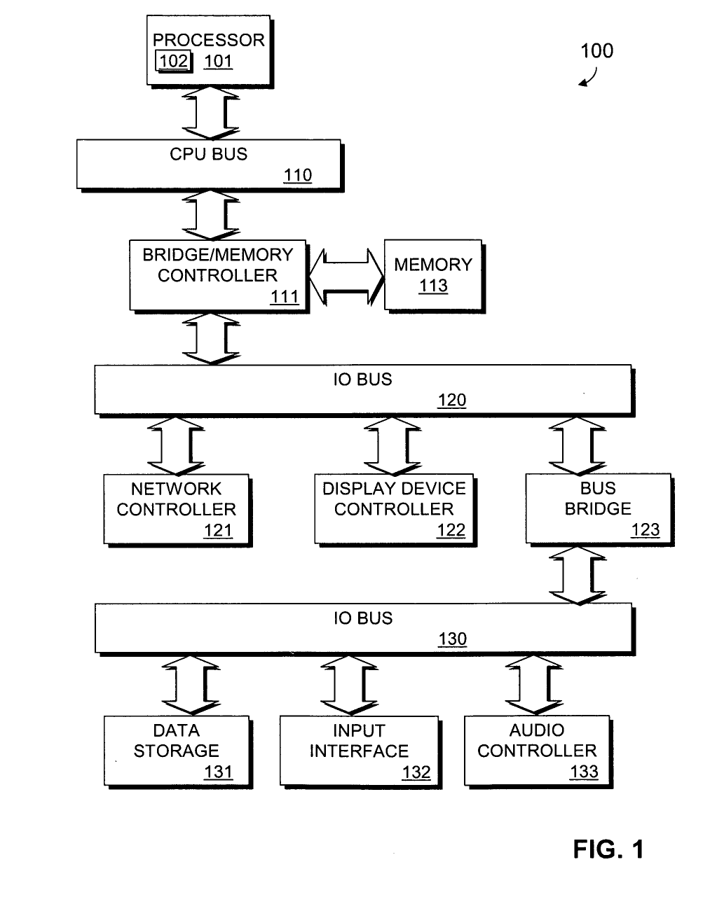

FIG. 1 is a block diagram of an exemplary computer system 100 according to an embodiment of the present invention. The computer system 100 includes a processor 101 that processes data signals and a memory 113. The processor 111 may be a complex instruction set computer microprocessor, a reduced instruction set computing microprocessor, a very long instruction word microprocessor, a processor implementing a combination of instruction sets, or other processor device. FIG. 1 shows the computer system 100 with a single processor. However, it is understood that the computer system 100 may operate with multiple processors. Additionally, each of the one or more processors may support one or more hardware threads. The processor 101 is coupled to a CPU bus 110 that transmits data signals between processor 101 and other components in the computer system 100.

The memory 113 may be a dynamic random access memory device, a static random access memory device, read-only memory, and/or other memory device. The memory 113 may store instructions and code represented by data signals that may be executed by the processor 101. According to an example embodiment of the computer system 100, a compiler may be stored in the memory 113 and implemented by the processor 101 in the computer system 100 to compile code. The compiler may generate assembly code for an instruction in the code that is to be performed by a first system. The compiler may also generate a directive for an instruction in the code that is to be performed by a second system. The assembly code may be used by a first system that may be, for example, an embedded system processor. The directive may be used by a second system that may be, for example, a development vehicle having a debugger unit. It should be appreciated that the development vehicle may also be stored in the memory 113.

A cache memory 102 resides inside processor 101 that stores data signals stored in memory 113. The cache 102 speeds access to memory by the processor 101 by taking advantage of its locality of access. In an alternate embodiment of the computer system 100, the cache 102 resides external to the processor 101. A bridge memory controller 111 is coupled to the CPU bus 110 and the memory 113. The bridge memory controller 111 directs data signals between the processor 101, the memory 113, and other components in the computer system 100 and bridges the data signals between the CPU bus 110, the memory 113, and a first IO bus 120.

The first IO bus 120 may be a single bus or a combination of multiple buses. The first IO bus 120 provides communication links between components in the computer system 100. A network controller 121 is coupled to the first IO bus 120. The network controller 121 may link the computer system 100 to a network of computers (not shown) and supports communication among the machines. A display device controller 122 is coupled to the first IO bus 120. The display device controller 122 allows coupling of a display device (not shown) to the computer system 100 and acts as an interface between the display device and the computer system 100.

A second IO bus 130 may be a single bus or a combination of multiple buses. The second IO bus 130 provides communication links between components in the computer system 100. A data storage device 131 is coupled to the second IO bus 130. The data storage device 131 may be a hard disk drive, a floppy disk drive, a CD-ROM device, a flash memory device or other mass storage device. An input interface 132 is coupled to the second IO bus 130. The input interface 132 may be, for example, a keyboard and/or mouse controller or other input interface. The input interface 132 may be a dedicated device or can reside in another device such as a bus controller or other controller. The input interface 132 allows coupling of an input device to the computer system 100 and transmits data signals from an input device to the computer system 100. An audio controller 133 is coupled to the second IO bus 130. The audio controller 133 operates to coordinate the recording and playing of sounds and is also coupled to the IO bus 130. A bus bridge 123 couples the first IO bus 120 to the second IO bus 130. The bus bridge 123 operates to buffer and bridge data signals between the first IO bus 120 and the second IO bus 130.

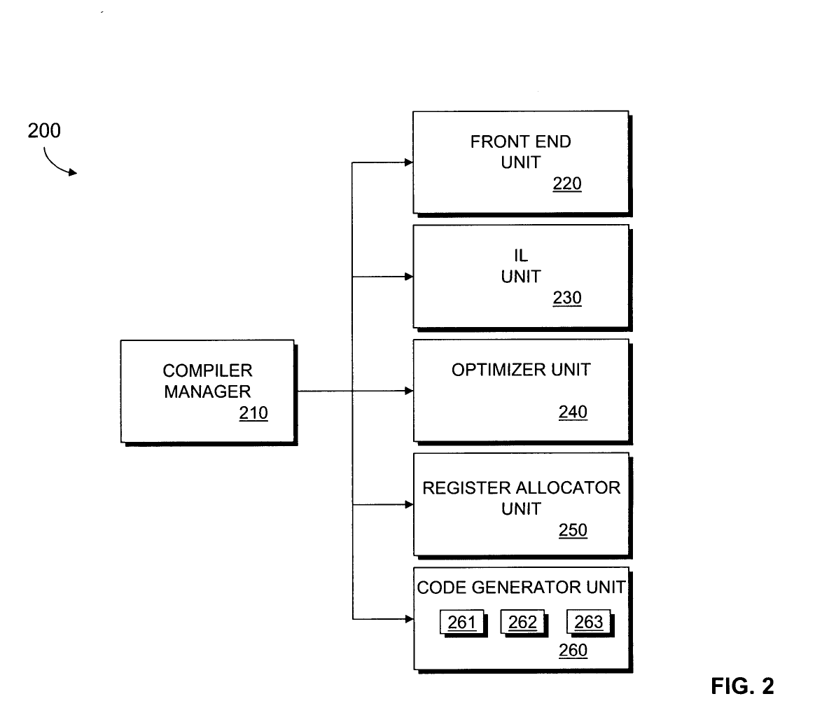

FIG. 2 is a block diagram that illustrates a compiler 200 according to an example embodiment of the present invention. The compiler 200 may be implemented on a computer system such as the one illustrated in FIG. 1. The compiler 200 includes a compiler manager 210. The compiler manager 210 receives code to compile. According to one embodiment, the code may include instructions to be performed by a first system and instructions to be performed by a second system. The compiler manager 210 interfaces with and transmits information between other components in the compiler 200.

The compiler 200 includes a front end unit 220. According to an embodiment of the compiler 200, the front end unit 220 operates to parse the code and convert it to an abstract syntax tree.

The compiler 200 includes an intermediate language (IL) unit 230. The intermediate language unit 230 transforms the abstract syntax tree into a common intermediate form such as an intermediate representation tree. It should be appreciated that the intermediate language unit 230 may transform the abstract syntax tree into one or more common intermediate forms.

The compiler 200 includes an optimizer unit 240. The optimizer unit 240 may perform procedure inlining and loop transformation. The optimizer unit 240 may also perform global and local optimization.

The compiler 200 includes a register allocator unit 250. The register allocator unit 250 identifies data in the intermediate representation tree that may be stored in registers in the processor rather than in memory.

The compiler 200 includes a code generator unit 260. The code generator unit 260 converts the intermediate representation tree into machine or assembly code. The assembly code is assigned program counters to indicate the order in which the lines of assembly code should be executed. The code generator unit 260 includes a directive unit 261. The directive unit 261 identifies instructions from the code that may be supported by the second system and generates a directive to direct the second system to perform the instructions. According to an embodiment of the present invention, the directive unit 261 generates a codeless intrinsic for the second system. The codeless intrinsic may be a task that the second system, such as a development vehicle utilizing a simulator or an external debugger agent in hardware, performs on the behalf of the program. The intrinsic is “codeless” in that it is transparent to the first system. The directive unit 261 also assigns a program counter to the codeless intrinsic. The program counter indicates when the codeless intrinsic should be executed relative to other instructions in the assembly code. The code generator unit 260 includes a no-operation unit 262. The no-operation unit 262 identifies instances where a no-operation instruction may need to be inserted into the assembly code to support the codeless intrinsic. According to an embodiment of the present invention, these instances may be infrequent. Compared with the utilization of code to implement an intrinsic, insertion of the no-operation instruction may still save code space and execution time. The code generator unit 260 includes a code off-load unit 263. The code off-load unit 263. The code off-load unit 263 identifies instances where instructions in the assembly code implement a function that is not required by the first system. The code off-load unit 263 removes those instructions from the assembly code and adds directions to a codeless intrinsic so that the second system performs the function instead.

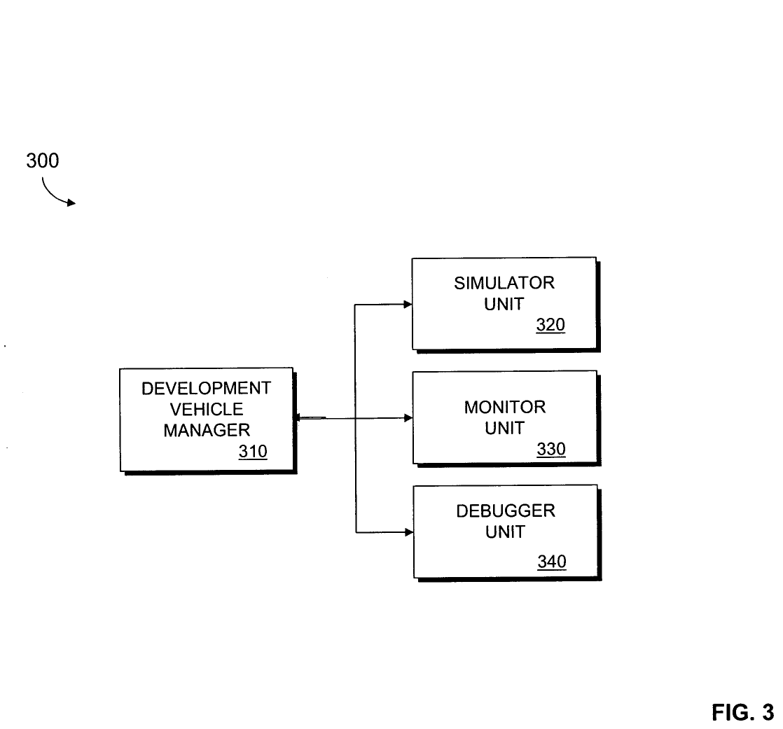

FIG. 3 is a block diagram that illustrates a development vehicle 300 according to an example embodiment of the present invention. The development vehicle 300 may be used to develop software for a first system such as an embedded processor. According to an embodiment of the present invention, the development vehicle 300 may be implemented on a computer system such as the one illustrated in FIG. 1. The development vehicle 300 includes a development vehicle manager 310. The development vehicle manager 310 receives assembly code and a directive that is passed from the compiler to a linker. The development vehicle manager 310 interfaces with and transmits information between other components in the development vehicle 300.

The development vehicle 300 includes a simulator unit 320. The simulator unit 320 emulates the characteristics of the first system and may be used to execute the assembly code generated for the first system. In an alternate embodiment of the present invention, an external hardware system may be used instead of the simulator unit 320. In this embodiment, information from the external hardware system would be transmitted to the development vehicle manager 310.

The development vehicle 300 includes a monitor unit 330. The monitor unit 330 identifies the program counter associated with assembly code that is being executed in the simulator 320 and determines whether a codeless intrinsic with a program counter following the program counter of the assembly code exists and is to be executed. According to an embodiment of the development vehicle 300, the monitor unit 330 generates an array link indexed by program counters from a directive. The array link may be used by the monitor unit 330 to efficiently look up whether an intrinsic is associated with a program counter and should be executed.

The development vehicle 300 includes a debugger unit 340. The debugger unit 340 allows a programmer to access information about a system emulated by the simulator unit 320 or an external hardware system that is being tested. The debugger unit 340 may support a number of operations and may be prompted to perform one or more of these operations by executing a codeless intrinsic identified by the monitor unit 330.

Embodiments of the present invention allow the compiler 200 (shown in FIG. 2) to off-load operations that assist a program during development, but are not needed in the production code. The operations are off-loaded to a debugger unit 340 in a development vehicle 300 (shown in FIG. 3) which performs the operations on the behalf of the program. Embodiments of the present invention enable the usage of operations that are otherwise not feasible in embedded systems with limited code size. Embodiments of the present invention also allow time savings when being emulated on a simulator.

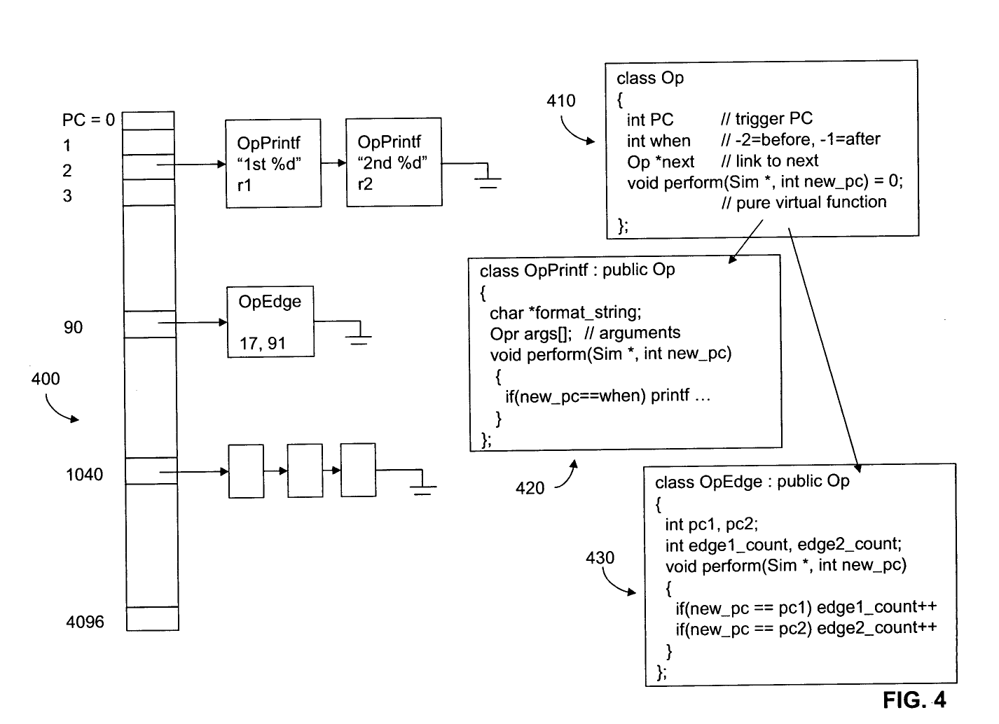

FIG. 4 illustrates an array pointer 400 generated by a monitor unit for a program according to an example embodiment of the present invention. Block 410 illustrates a C++ abstract class called Op. As shown, the class has four members, “PC”, the triggering program counter, “when”, a directional where −2 is PC− and −1 is PC+, “next”, a link to a next Op object, and “perform”, a pointer to a function that is to be specified.

Block 420 illustrates an object, OpPrintf, in the class Op 410. OpPrintf 420 implements a codeless intrinsic. It is a member of the class Op 410 and inherits its member data. OpPrintf 420 includes its own member data “format_string” and “args[ ]”.

Block 430 illustrates an object, OpEdge, in the class Op 410. OpEdge 430 implements a codeless intrinsic. It is a member of the class Op 410 and inherits its member data. OpEdge 430 includes its own member data “pc1”, “pc2”, “edge1_count”, “edge2_count”.

The array pointer 400 is indexed by program counters (PCs). The array pointer 400 ma be configured to reference a particular codeless intrinsic at its associated program counter. As shown, program counter 2 is associated with OpPrintf 420 and program counter 90 is associated with OpEdge 430. A monitor unit may reference the program counters of the array pointer 400 to determine when a codeless intrinsic is to be executed on behalf of a program.

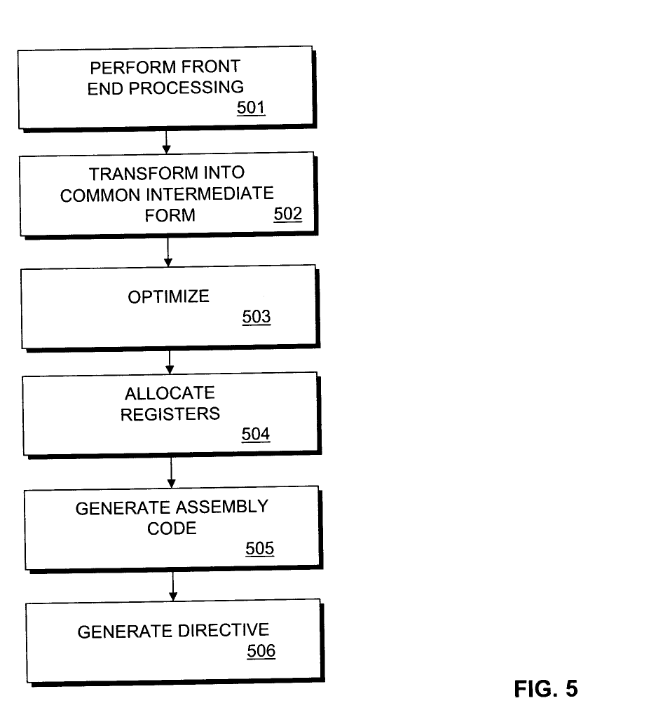

FIG. 5 is a flow chart of a method for compiling code according to an example embodiment of the invention. The code may include instructions to be performed by a first system and instructions to be performed by a second system. At 501, front end processing is performed on the code. According to an embodiment of the present invention, the code is parsed and converted to an abstract syntax tree.

At 502, the abstract syntax tree is transformed into a common intermediate form such as an intermediate representation tree. It should be appreciated that the abstract syntax tree may be transformed into one or more common intermediate forms.

At 503, optimization is performed. According to an embodiment of the present invention, procedure inlining and loop transformation may be performed. Global and/or local optimizations may also be performed.

At 504, register allocation is performed. According to an embodiment of the present invention, data in the intermediate representation tree is identified that may be stored in registers in the processor rather than in memory.

At 505, assembly code is generated. According to an embodiment of the present invention, instructions for the first system in the intermediate representation tree are converted into machine or assembly code. The assembly code is assigned program counters to indicate the order in which the lines of code should be executed.

At 506, a directive is generated. According to an embodiment of the present invention, instructions that may be supported by the second system are identified and used to generate a directive to direct the second system to perform the instructions. Generating the directive may include generating a codeless intrinsic for the second system. The codeless intrinsic may be a task that the second system, such as a development vehicle utilizing a simulator or an external debugger agent in hardware, performs on the behalf of the program. The intrinsic is “codeless” in that it is transparent to the first system. A program counter may also be assigned to the codeless intrinsic. The program counter indicates when the codeless intrinsic should be executed relative to other instructions in the assembly code. According to an embodiment of the present invention, directional program counters may be used for the codeless intrinsic, directions may be added to the codeless intrinsic to further off-load assembly code, and/or one or more no-operation instructions may be inserted into the assembly code when generating the directive.

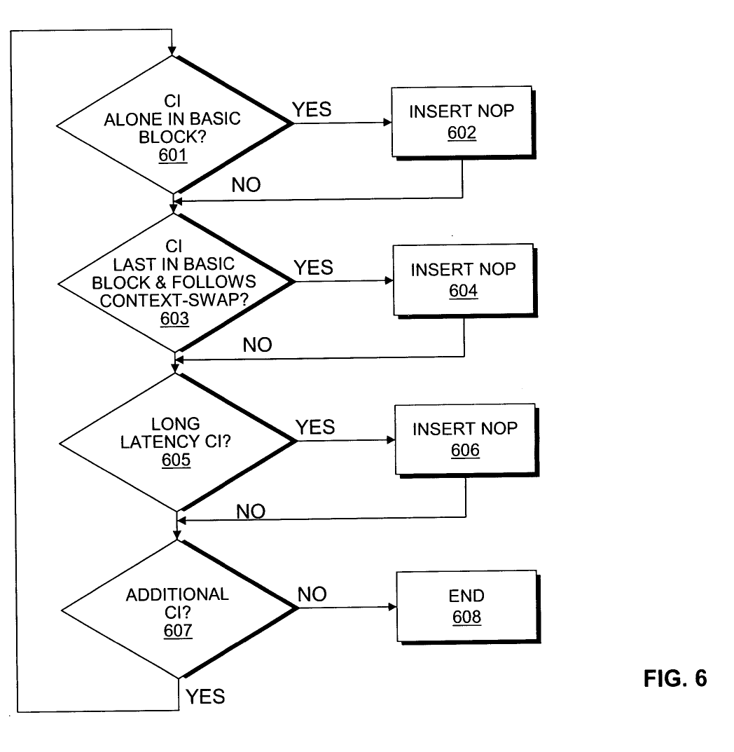

FIG. 6 is a flow chart illustrating a method for implementing no-operation instructions according to example embodiment of the present invention. The method shown in FIG. 6 may be implemented at 506 as shown in FIG. 5. At 601, it is determined whether the codeless intrinsic (CI) is the only instruction in a basic block. If the codeless intrinsic is the only instruction in the basic block, control proceeds to 602. If the codeless intrinsic is not the only instruction in the basic block, control proceeds to 603.

At 602, a no-operation (NOP) instruction is inserted into the assembly code before the codeless intrinsic.

The following illustrates exemplary assembly code and directives and their corresponding program counters for a codeless intrinsic that is the only instruction in a basic block. 7 is the program counter assigned to a no-operation instruction that is inserted in the assembly code. #7+ is the program counter assigned to the codeless intrinsic to indicate that the codeless intrinsic is to be executed after the no-operation instruction. Without the no-operation at program counter 7, the run-time system will execute the codeless intrinsic at either program counter 6+ or 8− regardless if the branch is taken or not.

```
    6 blt[rx, L]
    7 nop
  #7+ PRINTF “Branch fall-through”
L: 8 r1 [symbol] r1 + 1
```

At 603, it is determined whether a codeless intrinsic is a last instruction in a basic block and follows instructions causing a context-swap operation. If the codeless intrinsic is the last instruction in the basic block and follows instructions causing the context-swap operation, control proceeds to 604. If the codeless intrinsic is not the last instruction in the basic block and does not follow instructions causing a context-swap operation, control proceeds to 605.

At 604, a no-operation instruction is inserted into the assembly code before the codeless intrinsic.

The following illustrates exemplary assembly code and directives and their corresponding program counters for a codeless intrinsic that is the last instruction in a basic block and follows instructions which cause a context-swap operation. 8 is the program counter assigned to a no-operation instruction that is inserted in the assembly code. #8+ is the program counter assigned to the codeless intrinsic to indicate that the codeless intrinsic is to be executed after the no-operation instruction. Without the no-operation at program counter 8, the run-time system will execute the codeless intrinsic at 7+ which is before the context-swap.

```
  6 sram[read, ...], ctx_swap[s1], defer[1]
  7 r1 [symbol] 0 // execute after sram[read] command is issued, but before
                swap
  8 nop
#8+ PRINTF “The last in the block”
```

At 605, it is determined if the codeless intrinsic incurs long latency. If the codeless intrinsic incurs long latency, control proceeds to 606. If the codeless intrinsic does not incur long latency, control proceeds to 607.

At 606, one or more no-operation instructions are inserted into the assembly code before the codeless intrinsic.

The following illustrates exemplary assembly code and directives and their corresponding program counters for a codeless intrinsic that incurs long latency. 6 is the program counter assigned to a no-operation instruction that is inserted in the assembly code. #8− is the program counter assigned to the codeless intrinsic to indicate that the codeless intrinsic is to be executed after the no-operation instruction. A local memory can be accessed as a regular register operand as long as the pointer at program counter 3 is set-up with 3 intervening cycles beforehand. Without considering codeless intrinsic, two no-operation instructions are needed for the instruction at program counter 9 to access the local memory. To allow the second PRINTF to access the local memory at address 88, a third no-operation instruction is required at program counter 6. Without the no-operation at program counter 6, the new Im_addr value will not be available until the instruction at program counter 9 enters an execution stage.

```
  3 lm_addr0 [symbol] 88
  4 NOP
  5 NOP
  6 NOP
  7 r2 [symbol] r1 + 10
#8- PRINTF “register r2 = %d” r2
#8- PRINTF “local memory at addr 88 is %d” *lm_addr0
  9 rx [symbol] *lm_addr0 + 10
```

At 607, it is determined whether an additional codeless intrinsic needs to be examined. If an additional codeless intrinsic needs to be examined, control returns to 601. If an additional codeless intrinsic does not need to be examined, control proceeds to 608 and terminates the procedure.

It should be appreciated that directions may be added to a codeless intrinsic to off-load functions that would otherwise be performed on a first system onto a second system. Consider the following example.

```
  6 r1 [symbol] 0
L:
  7 r2 [symbol] r1 + 10
#8- PRINTF “x value is %d” r1 // r1 is data.x
#8- PRINTF “y value is %d” r2 // r2 is data.y
  8 r1 [symbol] r1 + 1
  9 r3 [symbol] r1 − 10
10 blt[r3, L]
```

The assembly code instruction at program counter 7 assigns a value to register r2. This operation is to be performed by the first system. However, the value at register r2 is only to be utilized by the second system as seen by the instruction at program counter #8−. Thus, in order to off-load the assembly code at program counter 7, the following modification can be made to the codeless intrinsic at program counter #8−.

#8- PRINTF “x value is %d” r1 // r1 is data.x
#8- PRINTF “y value is %d” r1+10 // r1+10 is data.y

By adding directions to the codeless intrinsic at program counter #8−, as shown above, the assembly code at program counter 7 may be removed.

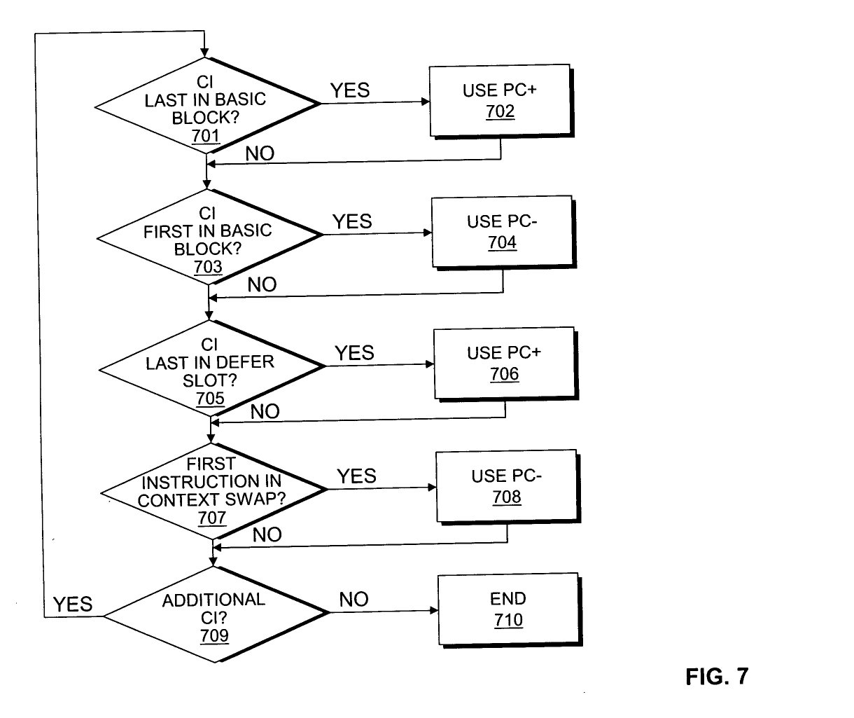

FIG. 7 is a flow chart illustrating a method for implementing directional program counters according to an example embodiment of the present invention. A directional program counter is a program counter that is assigned to a first instruction to indicate that the first instruction is to implemented immediately after a second instruction by adding a plus symbol to the program counter of the second instruction (PC+) or immediately before the second instruction by adding a minus symbol to the program counter of the second instruction (PC−). The method shown in FIG. 7 may be implemented at 506 as shown in FIG. 5. At 701, it is determined whether a codeless intrinsic (CI) is a last instruction of a basic block. A basic block may be described as a block of code where there is single entry and exit point. If the codeless intrinsic is the last instruction of the basic block control proceeds to 702. If the codeless intrinsic is not the last instruction in the basic block, control proceeds to 703.

At 702, a directional program counter that indicates that the codeless intrinsic should be executed after executing the last instruction in assembly code in the basic block is used (PC+).

At 703, it is determined whether the codeless intrinsic is a first instruction of a basic block. If the codeless instruction is the first instruction of the basic block, control proceeds to 704. If the codeless intrinsic is not the first instruction of the basic block, control proceeds to 705.

At 704, a directional program counter that indicates that the codeless intrinsic should be executed before the first instruction in assembly code in the basic block is used (PC−).

The following illustrates exemplary assembly code and directives and their corresponding program counters for a codeless intrinsic that is the last instruction of a basic block and a codeless intrinsic that is the first instruction of a basic block. #7+ is the program counter assigned to the codeless intrinsic that is the last instruction in a basic block. #8− is the program counter assigned to the codeless intrinsic that is the first instruction in a basic block.

```
    7 r1 [symbol] 0
  #7+ PRINTF “Outside of loop” // end of a block, use PC+
L: #8− PRINTF “Inside the loop” // beginning of a block, use PC-
    8 r1 [symbol] r1 + 1
    9 r3 [symbol] r1 − 10
  10 blt[r3, L]
```

At 705, it is determined whether the codeless intrinsic is a last instruction inside a defer slot. If the codeless intrinsic is the last instruction inside the defer slot control proceeds to 706. If the codeless intrinsic is not inside the defer slot, control proceeds to 707.

At 706, a directional program counter that indicates that the codeless intrinsic should be executed after the deferred operation is used (PC+).

At 707 it is determined whether the codeless intrinsic is the first instruction after a context-swap operation. If the codeless intrinsic is the first instruction after the context-swap operation, control proceeds to 708. If the codeless intrinsic is not the first instruction after the context-swap operation, control proceeds to 709.

At 708, a directional program counter that indicates that the codeless intrinsic should be executed before the context-swap operation is used (PC−).

The following illustrates exemplary assembly code and directives and their corresponding program counters for a codeless intrinsic that is the last instruction inside a defer slot and a first instruction after a context-swap operation. #7+ is the program counter assigned to the codeless intrinsic that is the last instruction inside the defer slot. #8− is the program counter assigned to the codeless intrinsic that is the first instruction after the context-swap operation.

```
  6 sram[read, ...], ctx_swap[s1], defer[1] // read from SRAM,
                                    swap out until completion
  7 r1 [symbol] 0 execute after sram[read] command is issued,
                    but before swap
#7+ PRINTF “Before context-swap”
#8− PRINTF “After context-swap back in”
  [r1 [symbol] r1 + 1
```

At 709, it is determined whether an additional codeless intrinsic needs to be examined. If an additional control intrinsic needs to be examined, control returns to 701. If an additional codeless intrinsic does not need to be examined, control proceeds to 710 where control terminates the procedure.

FIGS. 5-7 are flow charts illustrating exemplary embodiments of the present invention. Some of the procedures illustrated in the figures may be performed sequentially, in parallel or in an order other than that which is described. It should be appreciated that not all of the procedures described are required, that additional procedures may be added, and that some of the illustrated procedures may be substituted with other procedures.

In the foregoing specification, the embodiments of the present invention have been described with reference to specific exemplary embodiments thereof. It will, however, be evident that various modifications and changes may be made thereto without departing from the broader spirit and scope of the embodiments of the present invention. The specification and drawings are, accordingly, to be regarded in an illustrative rather than restrictive sense.

What is claimed is:

1. A method for compiling code, comprising:
generating assembly code for an instruction in the code that is to be performed by a first system;
identifying an instruction in the code that is supported by a second system; and
generating a directive that directs the second system to perform the instruction.

2. The method of claim 1, wherein the first system comprises a simulator unit.

3. The method of claim 1, wherein the first system comprises an embedded system processor.

4. The method of claim 1, wherein the second system comprises a debugger unit.

5. The method of claim 1, wherein generating the directive comprises:
generating a codeless intrinsic for the second system; and
assigning a program counter to the codeless intrinsic.

6. The method of claim 5, wherein assigning the program counter to the codeless intrinsic comprises assigning a directional program counter to indicate that the codeless intrinsic should be executed after executing a last instruction in assembly code in a basic block when the codeless instruction is the last instruction of the basic block.

7. The method of claim 5, wherein assigning the program counter to the codeless intrinsic comprises assigning a directional program counter to indicate that the codeless intrinsic should be executed before executing a first instruction in assembly code in a basic block when the codeless instruction is the first instruction of the basic block.

8. The method of claim 5, wherein assigning the program counter to the codeless intrinsic comprises assigning a directional program counter to indicate that the codeless intrinsic should be executed after a defer operation when the codeless intrinsic is a last instruction inside a defer slot.

9. The method of claim 5, wherein assigning the program counter to the codeless intrinsic comprises assigning a directional program counter to indicate that the codeless intrinsic should be executed before a context-swap operation when the codeless intrinsic is a first instruction after a context-swap.

10. The method of claim 1, further comprising inserting a no-operation instruction in the assembly code when a codeless intrinsic is alone in a block.

11. The method of claim 1, further comprising inserting a no-operation instruction in the assembly code when a codeless intrinsic is a last instruction in a block and follows an instruction that causes a context-swap.

12. The method of claim 5, wherein generating the codeless intrinsic comprises adding directions to perform a function that is not required by the first system.

13. An article of manufacture comprising a machine accessible medium including sequences of instructions, the sequences of instructions including instructions which, when executed, cause the machine to perform:
generating assembly code for an instruction in code that is to be performed by a first system;
identifying an instruction in the code that is supported by a second system; and
generating a directive that directs the second system to perform the instruction.

14. The article of manufacture of claim 13, wherein generating the directive comprises:
generating a codeless intrinsic for the second system; and
assigning a program counter to the codeless intrinsic.

15. The article of manufacture of claim 14, wherein the program counter comprises a directional program counter.

16. The article of manufacture of claim 14, wherein generating the codeless intrinsic comprises adding directions to perform a function that is not required by the first system.

17. A compiler, comprising:
a code generator unit to generate assembly code for an instruction in code that is to be performed by a first system and to generate a directive for an instruction in the code that is to be performed by a second system.

18. The apparatus of claim 17, wherein the code generator unit comprises a directive unit to generating a codeless intrinsic to the second system and to assign a program counter to the codeless intrinsic.

19. The apparatus of claim 17, wherein the code generator comprises a no-operation unit to insert no-operation instructions in the assembly code.

20. The apparatus of claim 17, wherein the code generator comprises a code off-load unit to add directions to a codeless intrinsic to perform a function that is not required by the first system.

21. A development vehicle, comprising:
a simulator unit to execute assembly code; and
a monitor unit to identify which assembly code the simulator unit is executing and whether a codeless intrinsic is to be executed.

22. The apparatus of claim 21, wherein the monitor unit determines whether a codeless intrinsic is to be executed from a directive.

23. The apparatus of claim 21, further comprising a debugger unit to execute the codeless intrinsic in response to the monitor unit.

24. A computer system, comprising:
a memory; and
a processor implementing a compiler having a code generator unit to generate assembly code for an instruction in the code that is to be performed by a first system and to generate a directive for an instruction in the code that is to be performed by a second system.

25. The computer system of claim 24, wherein the code generator unit comprises a directive unit to generating a codeless intrinsic to the second system and to assign a program counter to the codeless intrinsic.

26. The computer system of claim 24, wherein the code generator comprises a no-operation unit to insert no-operation instructions in the assembly code.

27. The computer system of claim 24, wherein the code generator comprises a code off-load unit to add directions to a codeless intrinsic to perform a function that is not required by the first system.
